(19) United States
(12) Patent Application Publication
(10) Pub. No.: US 2012/0036024 A1
(43) Pub. Date: Feb. 9, 2012

(54) MIXED AUCTIONS

(75) Inventors: Clarence C. Mysen, San Francisco, CA (US); Khanh B. Nguyen, Cupertino, CA (US); Jennifer Liu Low, Cupertino, CA (US); David A. Sloan, Palo Alto, CA (US); Gregory J. Friedman, Mountain View, CA (US)

(73) Assignee: GOOGLE INC., Mountain View, CA (US)

(21) Appl. No.: 12/852,360

(22) Filed: Aug. 6, 2010

(51) Int. Cl. G06Q 30/00

(52) U.S. Cl. 705/14.71

(57) ABSTRACT

In general, first bids associated with an ad request are identified, where the first bids have an auction value that is set at a bidding time. Second bids associated with the ad request are identified, where the second bids have an auction value that is unknown at the bidding time. One or more predicted auction values for the second bids are determined, and an auction is run to identify one or more winning bids from the first and second bids for satisfying the ad request.

### TECHNICAL FIELD

This disclosure relates generally to mixed auctions.

### BACKGROUND

Interactive media (e.g., the Internet) has great potential for improving the targeting of advertisements (“ads”) to receptive audiences. For example, some websites provide information search functionality that is based on keywords entered by the user seeking information. A user query can be an indicator of the type of information of interest to the user. By comparing the user query to a list of keywords specified by an advertiser, it is possible to provide targeted ads to the user.

Another form of online advertising is ad syndication, which allows advertisers to extend their marketing reach by distributing ads to additional partners. For example, third party online publishers can place an advertiser's text or image ads on web properties with desirable content to drive online customers to the advertiser's website.

### SUMMARY

Systems, methods and apparatus for providing mixed auctions are disclosed. In one implementation, first bids associated with an ad request are identified, where the first bids have an auction value that is set at a bidding time. Second bids associated with the ad request are identified, where the second bids have an auction value that is unknown at the bidding time. One or more predicted auction values for the second bids are determined, and an auction is run to identify one or more winning bids from the first and second bids for satisfying the ad request.

In another implementation, first bids associated with an ad request are identified, where the first bids have an auction value that is set at a bidding time. A second bid associated with the ad request is identified, where the second bid has an auction value that is unknown at the bidding time. An initial value is calculated for the second bid based at least in part on historical data. A correction factor is calculated, based at least in part on a value of a bid other than the second bid, to apply to the second bid. The correction factor is adjusted based at least in part on a risk associated with the second bid to generate an adjusted correction factor. An auction value is determined for the second bid based at least in part on the initial value and the adjusted correction factor. An auction is run to identify one or more winning bids from the first bids and the second bid for satisfying the ad request.

These and other implementations can optionally include one or more of the following features. Determining the one or more predicted auction values includes predicting a value for a future occurrence of an event associated with a second bid, and using the predicted value in comparing the second bid with other second bids and any first bids when running the auction. Determining the one or more predicted auction values includes creating a proxy value for each second bid using one or more models to predict potential purchases which will occur as the result of a presentation of an ad associated with a respective second bid. Determining the one or more predicted auction values includes multiplying predicted potential purchases with a bid revenue share associated with a respective second bid to create an expected value for the second bid and where running an auction includes comparing expected values for each second bid with auction values of each first bid to determine one or more winning bids. Running the auction includes running a second price auction to determine a winning bid. Running the second price auction includes pricing one of the one or more second bids based on a predicted value of a future occurrence of an event associated with a respective second bid. The second bid is a revenue-sharing bid. The revenue sharing bid represents a percentage of revenue associated with a given ad presentation. The first bids are per click, per impression or per conversion bids. A correction factor is determined to be applied to a predicted value for each second bid, and applying the correction factor to the predicted value prior to comparison with each other or comparison with auction values for the first bids. The correction factor is modified according to a risk associated with a prediction of a future occurrence of an event. An eCPM value is calculated for the first bids and the second bids prior to running the auction. A correction factor is determined to be applied to a final purchase price associated with the second bid after a conversion has been completed in connection with the second bid. The final purchase price is modified based on a calculated amount of risk.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online advertising system.

FIG. 2 is a flow diagram of an example process for managing bids in an auction.

FIG. 3 is a block diagram of another example online advertising system.

FIG. 4 is a flow diagram of an example process for managing a revenue-sharing bid.

FIG. 5 is a block diagram of a computing system.

Like reference numbers indicate like elements.

### DETAILED DESCRIPTION

Methods, systems, and apparatus including computer program products are described that relate to the distribution of information. Content providers (e.g., advertisers) may provide one or more bids in an auction whose value is known at the time of bid. Some content providers may provide a bid in an auction whose value is unknown at the time of bid, such as for example, bids that are tied to a percentage of revenue sharing. Techniques are described for valuing both types of bids, comparing them, and pricing them so as to provide efficient delivery of content through a content delivery system.

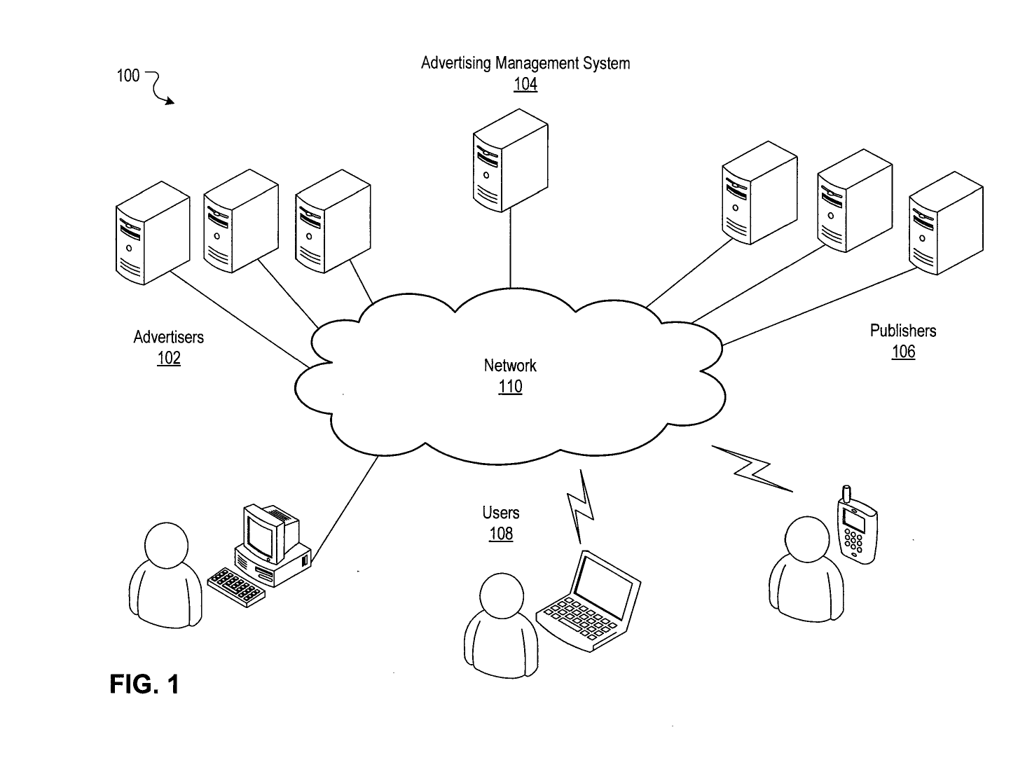

FIG. 1 is a block diagram of an example an online advertising system 100. In some implementations, one or more advertisers 102 can directly, or indirectly, enter, maintain, and track advertisement (“ad”) information in an advertising management system 104. Though reference is made to advertising, other forms of content, including other forms of sponsored content, can be delivered by the system 100. The ads may be in the form of graphical ads, such as banner ads, text only ads, image ads, audio ads, video ads, ads combining one of more of any of such components, etc. The ads may also include embedded information, such as a links, meta-information, and/or machine executable instructions. One or more publishers 106 may submit requests for ads to the system 104. The system 104 responds by sending ads to the requesting publisher 106 for placement on one or more of the publisher's web properties (e.g., websites and other network-distributed content). The ads can include embedded links to landing pages, e.g., pages on the advertisers 102 websites, that a user is directed to when the user clicks an ad presented on a publisher website.

Other entities, such as users 108 and the advertisers 102, can provide usage information to the system 104, such as, for example, whether or not a conversion or click-through related to an ad has occurred. This usage information can include measured or observed user behavior related to ads that have been served. The system 104 performs financial transactions, such as crediting the publishers 106 and charging the advertisers 102 based on the usage information.

A computer network 110, such as a local area network (LAN), wide area network (WAN), the Internet, or a combination thereof, connects the advertisers 102, the system 104, the publishers 106, and the users 108.

One example of a publisher 106 is a general content server that receives requests for content (e.g., articles, discussion threads, music, video, graphics, search results, web page listings, information feeds, etc.), and retrieves the requested content in response to the request. The content server may submit a request for ads to an ad server in the system 104. The ad request may include a number of ads desired. The ad request may also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server can combine the requested content with one or more of the ads provided by the system 104. This combined content and ads can be sent to the user 108 that requested the content for presentation in a viewer (e.g., a browser or other content display system). The content server can transmit information about the ads back to the ad server, including information describing how, when, and/or where the ads are to be rendered (e.g., in HTML or JavaScript™)

Another example publisher 106 is a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of (e.g., ten) search results.

The search service can submit a request for ads to the system 104. The request may include a number of ads desired. This number may depend on the search results, the amount of screen or page space occupied by the search results, the size and shape of the ads, etc. In some implementations, the number of desired ads will be from one to ten, or from three to five. The request for ads may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

The search service can combine the search results with one or more of the ads provided by the system 104. This combined information can then be forwarded to the user 108 that requested the content. The search results can be maintained as distinct from the ads, so as not to confuse the user between paid advertisements and presumably neutral search results.

Finally, the search service can transmit information about the ad and when, where, and/or how the ad was to be rendered back to the system 104.

As can be appreciated from the foregoing, the advertising management system 104 can serve publishers 106, such as content servers and search services. The system 104 permits serving of ads targeted to documents served by content servers. For example, a network or inter-network may include an ad server serving targeted ads in response to requests from a search service with ad spots for sale. Suppose that the inter-network is the World Wide Web. The search service crawls much or all of the content. Some of this content will include ad spots (also referred to as “inventory”) available. More specifically, one or more content servers may include one or more documents. Documents may include web pages, email, content, embedded information (e.g., embedded media), meta-information and machine executable instructions, and ad spots available. The ads inserted into ad spots in a document can vary each time the document is served or, alternatively, can have a static association with a given document.

In some examples, the advertisement management system 104 may include an auction process to select advertisements. Advertisers may be permitted to select, or bid, an amount the advertisers are willing to pay for each click of an advertisement, e.g., a cost-per-click amount an advertiser pays when, for example, a user clicks on an advertisement. The cost-per-click can include a maximum cost-per-click, e.g., the maximum amount the advertiser is willing to pay for each click of advertisement based on targeting criteria (e.g., one or more keywords). For example, advertisers A, B, and C all select, or bid, a maximum cost-per-click of $0.50, $0.75, and $1.00, respectively. The maximum amount advertiser A will pay for a click is $0.50, the maximum amount advertiser B will pay is $0.75, and the maximum amount advertiser C will pay is $1.00.

The rank of an advertisement that is displayed can be determined by multiplying the maximum cost-per-click for the advertisement by a quality score of the advertisement. The advertisement can then be placed among other advertisements in order of increasing or decreasing rank. For example, suppose the quality score of advertisers A, B, and C are “3,” “1,” and “1,” respectively. The rank of advertiser A, B, and C can be determined as follows:
A: Rank=quality score×maximum cost-per-click=3.0×$.50=1.50
B: Rank=quality score×maximum cost-per-click=1.0×$0.75=0.75
C: Rank=quality score×maximum cost-per-click=1.0×$1.00=1.00

The advertisers can be ranked as follows:
1. A
2. C
3. B

The advertisements can also be priced and ordered according to a second price auction. In addition to the cost-per-click of the advertisement and the quality score of the advertisement, a second price auction may adjust the price of an advertisement at bidding time by considering the amount selected or bid by the advertiser directly ranked below a given advertisement. For example, the “second price” (sometimes referred to as an “actual cost per click”) of an advertisement can be the price that is necessary to keep the advertisement's position above the next advertisement. To determine the second price, the system 104 can determine how much the advertiser in position 1 would have to pay to give them a rank equal to the advertiser in position 2, and then the system 104 adds a unit amount, e.g., $0.01, to this determined amount.

To determine how much the advertiser in position 1 would have to pay to give them a rank equal to the advertiser in position 2, the rank of position 2 can be divided by the quality score of position 1 and $0.01 can be added to that amount. The last advertiser in the list can pay a minimum cost-per-click to hold the position in the list. For example, suppose the minimum cost-per-click is $0.20. The second price of advertisers A, B, and C can be determined as follows:
A: C's rank/A's quality score=⅓=$0.33+$0.01=$0.34
C: B's rank/C's quality score=0.75/1=$0.75+$0.01=$0.76
B: minimum cost-per-click=$0.20

In this example, A would only have to pay $0.34 to hold the first position in the list of advertisements. C would have to pay $0.76 to hold the second position. Advertiser B would be required to pay the minimum cost-per-click amount of $0.20.

Another metric for ranking and valuing advertisements is effective cost-per-thousand impressions (eCPM). The eCPM value represents the estimated earnings for every 1000 “impressions” an advertiser receives. An impression refers to the number of times a web page or pages containing a particular advertisement are shown to page visitors.

When the cost-per-click is known, such as in the auction scheme described above, eCPM can be calculated according to the following formula:

eCPM=1000×CPC×(Probability of Click)

The probability of click factor can be supplied based on historical data associated with an advertisement, a merchant, industry-wide data, or other factors. Thus, when an advertiser provides a cost-per-click bid, the eCPM formula can represent an advertiser's estimated earnings for every 1000 impressions received. Second price auctions such as those described above can also use eCPM values to create a second price value for an advertisement.

In some situations, instead of bidding for an advertisement on a cost-per-click basis, an advertiser might prefer to place bids on an advertisement based on other factors. For example, an advertiser may wish to bid using a revenue sharing bid. In some examples, a revenue sharing bid is a bid for an advertisement based on a fraction of the advertiser's sales which are attributable to a given advertisement, and may be sales associated with a single product, related products, categories of products, or plural categories, or alternatively may be related to sales at a location, in a given time, or in accordance with other agreed upon sharing of revenue. Other forms of revenue sharing are possible as agreed to between the advertiser and the advertising management system. This manner of bid may allow an advertiser to have greater control over their return on investment, as the cost of an advertisement correlates closely with the sales generated by that advertisement. However, because advertisers bid for advertisements prior to generating sales based on those advertisements, a mechanism is required for dealing with the unknown values, such as purchase values, in order to combine revenue-share bids with cost-per-click bids in the same auction.

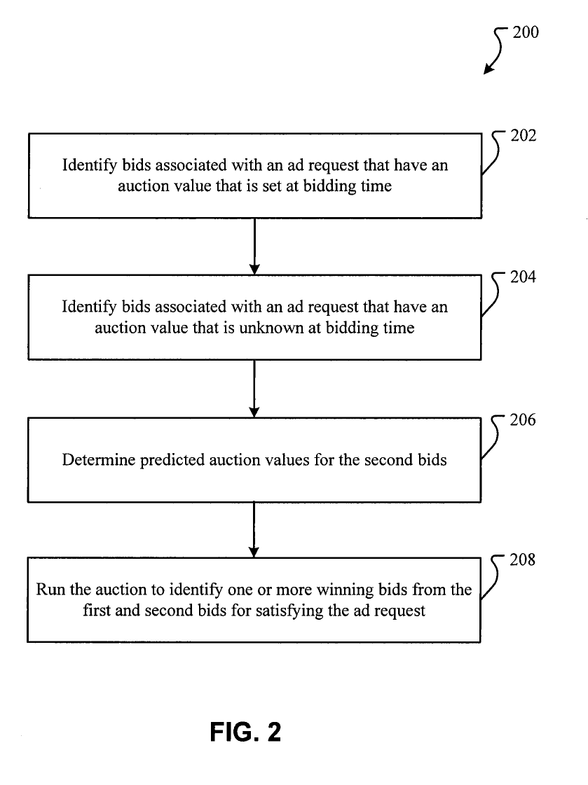

FIG. 2 is a simplified example process 200 for combining bids that have an auction value that is set at bidding time (e.g., cost-per-click bids) with bids that have an auction value that is unknown at bidding time (e.g., revenue-sharing bids). Auctions that include both cost-per-click bids and revenue-share bids are referred to as mixed auctions. In some examples, the advertising management system 104 can perform the techniques associated with the process 200. The advertising management system 104 identifies bids that are associated with an ad request that have an auction value that is set at bidding time (202). For example, the advertising management system 104 can identify cost-per-click bids submitted by advertisers, and the cost-per-click bids can have an auction value of:

eCPM=1000×CPC×(Probability of Click)

Likewise, the advertising management system 104 identifies bids that are associated with an ad request that have an auction value that is unknown at bidding time (204). For example, the advertising management system 104 can identify bids that are revenue-sharing bids.

After the advertising management system 104 has identified one or more bids having values that are unknown at bidding time, the advertising management system 104 determines predicted auction values for those bids (206). In some implementations, the advertising management system 104 determines predicted auction values for bids having unknown values by creating proxy values of those bids through the use of predictive models. After the advertising system 104 creates proxy values for one or more of the bids having unknown values, the advertising system 104 conducts an auction to identify one or more “winning” bids that satisfy an ad request (208). Because the advertising management system 104 is able to assign proxy values to bids with unknown values, bids such as revenue-share bids can be evaluated against traditional cost-per-click bids whose values are known. The manner in which proxy values are assigned is described in further detail below.

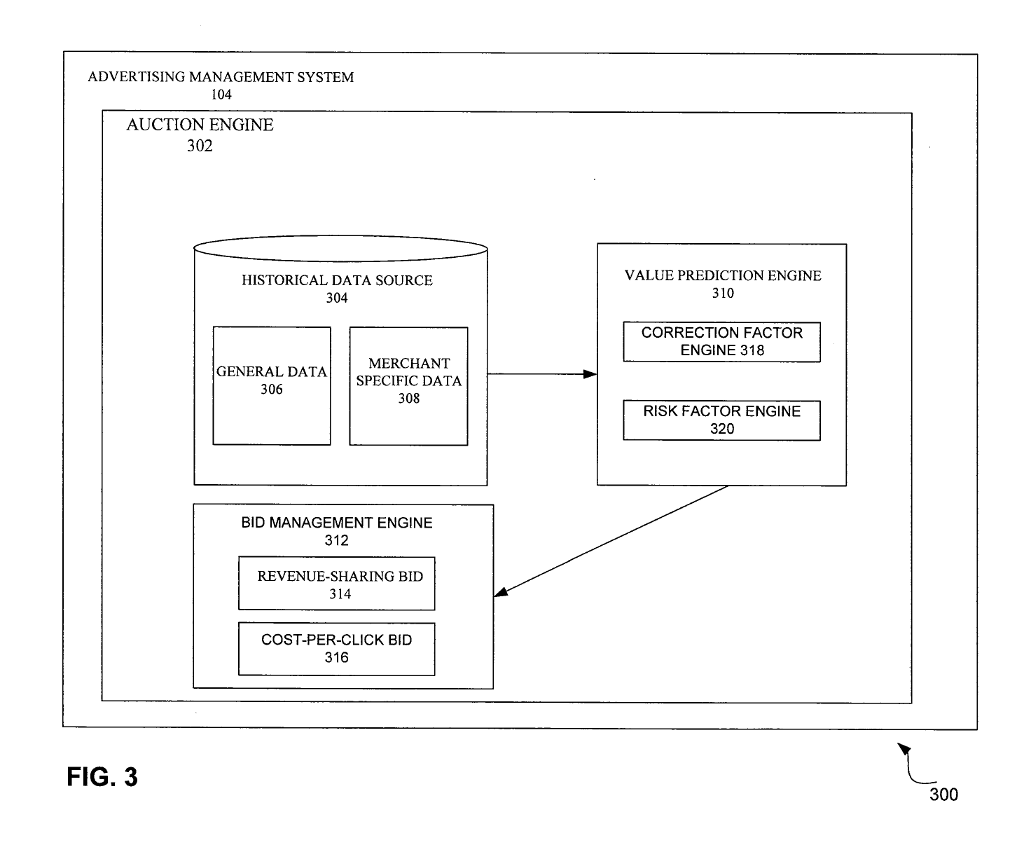

FIG. 3 is an example system 300 that includes the advertising management system 104 and various subcomponents. The advertising management system 104 includes an auction engine 302 to perform one or more of the functions described above, such as ordering bids, second-pricing bids, and executing auctions. The advertising management system 104 also includes a bid management engine 312 for managing different types of bids for advertisements, such as revenue-sharing bid 314 and cost-per-click bid 316. The advertising management system 104 also includes a value prediction engine 310 that communicates with both a historical data source 304 and the bid management engine 312. The historical data source 304 includes various types of data, such as general data (e.g., general commercial activity data and general trend data) and merchant specific data 308.

The value prediction engine 310 controls the determination of proxy values for revenue-sharing bid 314. Like with cost-per-click bids, an eCPM value can be calculated for revenue-sharing bid 314 using, for example, predictive models. For example, because a cost-per-click value does not exist for the revenue-sharing bid 314, the eCPM value is calculated differently for the revenue-sharing bid 314. The value prediction engine 310 uses the following formula to calculate a proxy eCPM value for the revenue-sharing bid 314:

eCPM=1000×(Expected Purchase Value)×(Revenue Share)×(Probability of Purchase)

In general, the Revenue Share is a known value, as it represents the percentage of each sale that a merchant is willing to pay in lieu of a cost-per-click. For example, instead of submitting a bid based on a cost-per-click, a merchant may choose to submit a bid based on payment of 10% of each sale. Thus, the Revenue Share would be 10%—a known quantity.

In some examples, the value prediction engine 310 estimates the Expected Purchase Value and Probability of Purchase factors. In some implementations, these factors are a function of many variables. The Expected Purchase Value can represent the amount of money a customer is expected to spend when completing a purchase associated with an impression, and the Probability of Purchase factor can represent the likelihood that a customer will complete a purchase with a particular merchant given the impression. In some examples, the value prediction engine 310 uses the general data 306 and the merchant specific data 308 stored in historical data source 304 to predict values for the revenue-sharing bid 314, and for the Expected Purchase Value and Probability of Purchase factors, specifically.

In the case where the advertising management system 104 has no available data for a merchant that submits a revenue-sharing bid (e.g., a newly-formed merchant), the value prediction engine 310 can use general data 306 in order to predict values for unknown factors. For example, if a new merchant that deals in cameras submits a revenue-sharing bid, the value prediction engine 310 can examine general data 306 to identify the Expected Purchase Value and Probability of Purchase factors of other camera merchants. The value prediction engine 310 can also attempt to estimate values for these factors by examining general data 306 that relates to past purchases given similar queries, or past purchases given similar categories of products. For example, cameras might be classified as being in the “electronics” category, so the value prediction engine 310 could use general data 306 from past electronics purchases to estimate values for the Expected Purchase Value and Probability of Purchase factors. Likewise, if the revenue-sharing bid is associated with a query such as “cheap cameras,” the value prediction engine 310 could use general data 306 to identify the Expected Purchase Value and Probability of Purchase associated with past purchases that occurred in connection with a similar or identical query. Estimates can also consider a merchant ratings, a size of the merchant, a quality of the merchant's website, and other factors.

If the historical data source 304 contains sufficient data from past transactions with a merchant that has submitted a revenue-sharing bid, the value prediction engine can also use merchant specific data 308 to determine values for the Expected Purchase Value and Probability of Purchase factors. For example, if a merchant submitting a revenue-sharing bid has submitted a number of such bids in the past and had completed sales in connection with those previous bids, historical data source 304 may already contain useful Expected Purchase Value and Probability of Purchase factor values (in the form of merchant specific data 308) that can be used to determine current Expected Purchase Value and Probability of Purchase factor values.

Merchant specific data can also include modifiers that affect the Expected Purchase Value. For example, the merchant specific data 308 may include statistics that show that when a particular merchant sells a camera with a purchase price of $300, the customer usually ends up purchasing $330 worth of goods from that merchant. In that case, the merchant may have a Expected Purchase Value modifier of 1.1, as the merchant's sales have historically resulted in a 10% higher revenue than the item targeted by the ad associated with the revenue-sharing bid. Thus, for future revenue-sharing bids, the Expected Purchase Value can be increased by 10% to reflect that merchant's historic trend of upselling customers. Factor modifiers can also be based on general data 306. For example, if the general data 306 shows that the purchase of electronic items usually results in a 10% higher total purchase price than the price of the targeted item, a similar modifier to that described above can be applied to the Expected Purchase Value. Positive and negative modifiers can be used in conjunction with determining the Expected Purchase Value and Probability of Purchase factor values. In this way, the initial eCPM can be made more accurate.

As with cost-per-click bids, once an initial eCPM value has been determined using the formula eCPM=1000×(Expected Purchase Value)×(Revenue Share)×(Probability of Purchase), the value prediction engine 310 or the bid management engine 312 can determine a second price for the revenue sharing bid 314, as well as any other bids in the second auction (e.g., cost-per-click bid 316). In some examples, the second price for a mixed auction can be computed in the form of a correction factor “k.” The correction factor k can be immediately applied to any values known at impression time (e.g., the cost-per-click value) and, especially in the case of revenue share bids, can be stored for use at a time when true values (e.g., an actual purchase price) are known. In some implementations, the correction factor k is calculated according to the following formula:

k=(maximum eCPM of second place bidder/maximum eCPM of self)

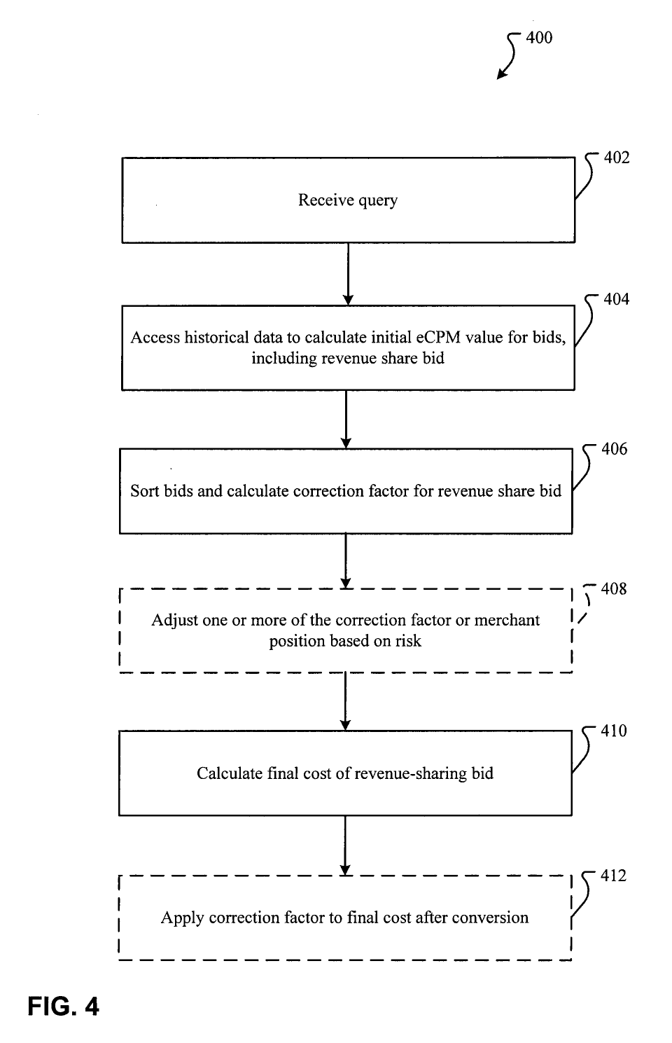

As described below with regard to FIG. 4, the correction factor k can be modified based on other factors, such as auctioneer risk. Once the value of k has been calculated, the correction value k can be used to calculate the final cost of a revenue share purchase according to the formula:

final cost=k×(Revenue Share)×(Actual Purchase Amount)

An example of how the correction value k can affect the final cost of a revenue share purchase is shown in the example of FIG. 4 below.

FIG. 4 is an example process 400 for determining an initial value and a second price for a revenue share bid. This example illustrates a case in which a merchant (“Merchant X”) has agreed to participate in a revenue-sharing bid arrangement, whereby 10% of Merchant X's sales would be paid as commission to the auctioneer associated with the advertising management system 104. The example illustrated in FIG. 4 also assumes that merchant-specific historical data is available for Merchant X. FIG. 4 further illustrates an example in which an auction contains both cost-per-click and revenue-sharing bids.

The process 400 begins when the advertisement system 104 receives a query (sometimes referred to as a “query event”) (402). For example, a customer submits a query (e.g., in a search engine) for a widget, and Merchant X's widget appears in the candidate list for widgets. The value prediction engine 310 accesses the historical data source 304 in order to calculate an initial eCPM value for both revenue-sharing and cost-per-click bids (404). The value prediction engine 310 uses general data 306 and merchant specific data 308 to determine that, historically, customers submitting a query for widgets click on advertisements for widgets 10% of the time, purchase widgets from the advertised merchant 5% of the time that they click on the advertisement and, for widgets valued at $50, customers usually have a total purchase price of $55. Thus, in the example of FIG. 4, the initial eCPM for the Merchant X's revenue sharing bid is:

eCPM=1000×(Expected Purchase Value)×(Revenue Share)×(Probability of Purchase); or:

eCPM=1000×($55)×(10%)×(5%)=$275

The eCPM is also calculated for the cost-per-click bids.

After all the initial eCPM values have been calculated (and any incremental value has been added to a bid, such as $0.01), all of the bids are sorted by their eCPM values to allow for the value prediction engine to calculate the correction factor k (406). For example, assume that the operations discussed above result in the following sorted list of bids:
Bid A (CPC bid 1): $300
Bid B (Merchant X's revenue-sharing bid): $275
Bid C (CPC bid 2): $165

The correction factor for Merchant X's revenue-sharing bid is calculated as follows:

k=(maximum eCPM of second place bidder/maximum eCPM of self); or

k(Bid B)=$165/$275=0.6

Thus, the correction factor k for Merchant X's revenue-sharing bid is 0.6.

In some examples, a risk factor engine 320 can optionally modify the value of the correction factor k (408). The risk factor engine 320 can use general data 306 or merchant-specific data 308 in order to modify the correction factor based on historical risk associated with Merchant X or any similar transactions. For example, if the risk factor engine 320 determines (from either or both of general or merchant specific data) that a revenue-sharing bid is risky, the correction factor k can be adjusted to account for the risk assumed by the auctioneer in accepting a revenue-sharing bid. For instance, if historical data shows that purchases of widgets are risky, the risk factor engine 320 can adjust the correction factor k by, for example, 10%, with its adjusted value being 0.66. In addition to (or instead of) adjusting the correction factor k by 10%, the risk factor engine can also force Merchant X into a position that is 10% dollars lower than his current position. For example, the following new sorted list of bids could result from this type of risk adjustment:
Bid A (CPC bid 1): $300
Bid B (Merchant X's revenue-sharing bid): $247.5
Bid C (CPC bid 2): $165
   In this example, the order of the bids would not change as a result of this type of risk adjustment. However, this type of risk adjustment can influence advertisers to bid higher amounts to overcome their risk penalty in an effort to remain competitive with other bidders.

For the risk analysis, in some implementations the system operates to predict the purchases for the advertiser over time and evaluate how accurate these predictions are. The system can then can use the errors to see how similar this particular advertiser is to other advertisers in terms of “unpredictability” (looking at changes and irregularities in the conversion rates and in the errors in purchase amount). In some implementations, these predictive irregularities make up the “risk” for a given advertiser. In some implementations, higher error rates can be applied using, for example, a function of the irregularity score for the advertiser to apply the risk correction. In some implementations, a comparison of the variance of the advertiser as against other advertisers is made and a simple linear function of the ratio of the advertiser's variance divided by the average variance for similar advertisers (indicating how risky they are compared to the average) is used. In some implementations, non-linear functions of an “irregularity score” can be used to for identifying the risk, rather than, or in addition to statistical models like measures of variance.

Assuming that the risk factor engine 320 accounted for risk by adjusting the correction factor k to equal 0.66, and that the customer eventually purchased a widget from Merchant X for $50, the advertisement management system 104 can calculate the final cost (or second price) of the purchase. In this example, the final cost of the purchase would be calculated (410) as:

final cost=k×(Revenue Share)×(Actual Purchase Amount); or

final cost=0.66×(10%)×($50)≈$2.18

Thus, Merchant X would owe the auctioneer $2.18.

In some examples, in contrast to the modification of a cost-per-click bid in which a correction factor is applied immediately (e.g., before a purchase occurs), in a revenue-sharing bid, the correction factor can be applied to the bid after the conversion (e.g., the purchase) occurs (412). In this way, the auctioneer can decrease (or increase) the cost of the revenue-share purchase according to the correction factor after the true values are known for a particular transaction.

As described above, an actual purchase amount (a “price component”) is required to be determined in order to calculate how much an advertiser is charged for a given revenue-sharing bid. In order to determine the price component, a determination is made as to which activities of the customer are to be attributed to a given presentation of an ad (or a series of ads). In some implementations, a bid may be associated with a single product or service, related products or services, a category, multiple categories of products or services, a time window, a location, or other parameters. The determination of which activities of a user are attributable to which bid can be made by agreement between the parties. Multiple bids may also be associated with a singular activity (e.g., the purchase of a singular product may be attributable to two different bids). Accordingly, many different types of revenue sharing between the advertiser, publisher and advertising system are possible.

Upon completing the transaction, the historical data can be updated to reflect the details of the transaction, which improves the accuracy of the eCPM calculations. For example, the general data 306 can be updated for the general sales of widgets, and merchant-specific data 308 for Merchant X can be updated to reflect some other circumstance of the transaction. For example, if Merchant X consistently sells widgets to 50% of the users that click on Merchant X's advertisements, the Probability of Purchase factor can be updated to reflect this trend. Merchant X's risk factor can also be raised or lowered as a result of trending data related to his transactions, or to transactions within Merchant X's general industry, transactions with merchants of similar size to Merchant X, and the like.

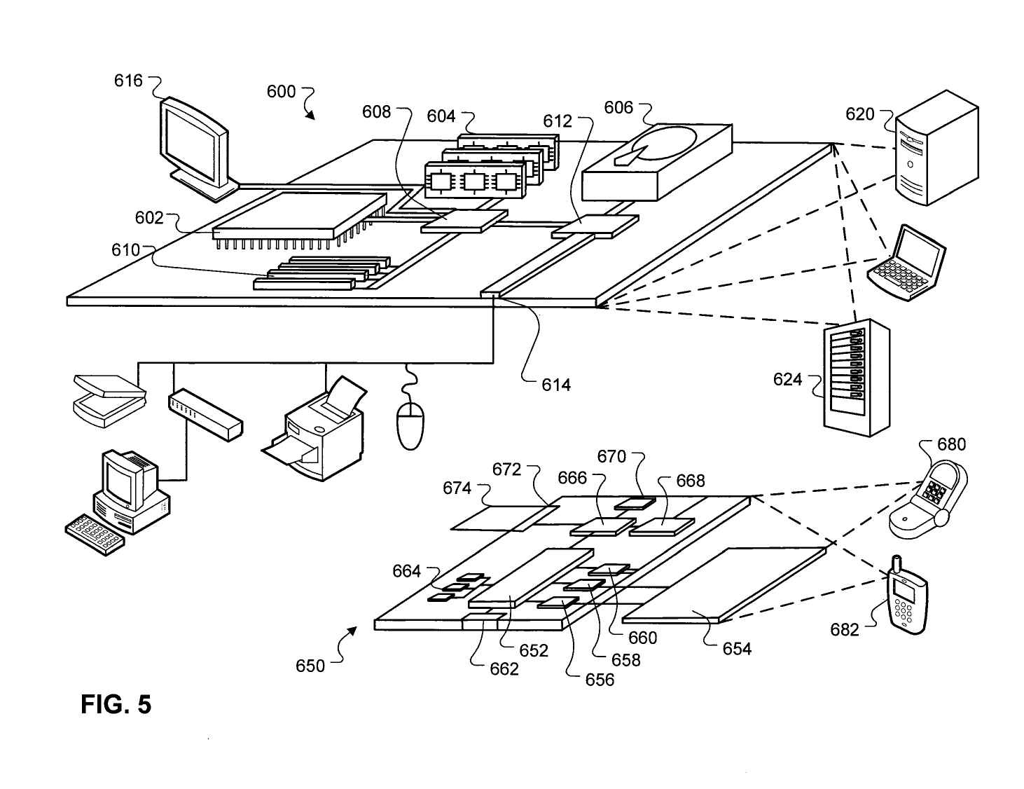

FIG. 5 shows an example of a computing device 1000 and a mobile computing device 650 that can be used to implement the techniques described here. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602).

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A method comprising
identifying first bids associated with an ad request where the first bids have an auction value that is set at a bidding time;
identifying second bids associated with the ad request where the second bids have an auction value that is unknown at the bidding time;
determining one or more predicted auction values for the second bids; and
running an auction to identify one or more winning bids from the first and second bids for satisfying the ad request.

2. The method of claim 1, wherein determining the one or more predicted auction values comprises:
predicting a value for a future occurrence of an event associated with a second bid; and
using the predicted value in comparing the second bid with other second bids and any first bids when running the auction.

3. The method of claim 1, wherein determining the one or more predicted auction values comprises creating a proxy value for each second bid using one or more models to predict potential purchases which will occur as the result of a presentation of an ad associated with a respective second bid.

4. The method of claim 1, wherein determining the one or more predicted auction values comprises multiplying predicted potential purchases with a bid revenue share associated with a respective second bid to create an expected value for the second bid and where running an auction includes comparing expected values for each second bid with auction values of each first bid to determine one or more winning bids.

5. The method of claim 1, wherein running the auction comprises running a second price auction to determine a winning bid.

6. The method of claim 5, wherein running the second price auction comprises pricing one of the one or more second bids based on a predicted value of a future occurrence of an event associated with a respective second bid.

7. The method of claim 1, wherein the second bid is a revenue-sharing bid.

8. The method of claim 7, wherein the revenue sharing bid represents a fraction of sales associated with a given ad presentation.

9. The method of claim 1, where the first bids are per click, per impression or per conversion bids.

10. The method of claim 1, further comprising determining a correction factor to be applied to a predicted value for each second bid, and applying the correction factor to the predicted value prior to comparison with each other or comparison with auction values for the first bids.

11. The method of claim 10, further comprising modifying the correction factor according to a risk associated with a prediction of a future occurrence of an event.

12. The method of claim 1, further comprising calculating an eCPM value for the first bids and the second bids prior to running the auction.

13. The method of claim 1, further comprising determining a correction factor to be applied to a final purchase price associated with the second bid after a conversion has been completed in connection with the second bid.

14. The method of claim 13, further comprising modifying the final purchase price based on a calculated amount of risk.

15. A method comprising identifying first bids associated with an ad request where the first bids have an auction value that is set at a bidding time;
identifying a second bid associated with the ad request where the second bid has an auction value that is unknown at the bidding time;
calculating an initial value for the second bid based at least in part on historical data;
calculating, based at least in part on a value of a bid other than the second bid, a correction factor to apply to the second bid;
adjusting the correction factor based at least in part on a risk associated with the second bid to generate an adjusted correction factor;
determining an auction value for the second bid based at least in part on the initial value and the adjusted correction factor; and
running an auction to identify one or more winning bids from the first bids and the second bid for satisfying the ad request.

16. A computer storage device comprising executable instructions that, when executed by one or more processors cause the one or more processors to:
identify first bids associated with an ad request where the first bids have an auction value that is set at a bidding time;
identify second bids associated with the ad request where the second bids have an auction value that is unknown at the bidding time;
determine one or more predicted auction values for the second bids; and
run an auction to identify one or more winning bids from the first and second bids for satisfying the ad request.

17. A computer storage device comprising executable instructions that, when executed by one or more processors cause the one or more processors to:
identify first bids associated with an ad request where the first bids have an auction value that is set at a bidding time;
identify a second bid associated with the ad request where the second bid has an auction value that is unknown at the bidding time;
calculate an initial value for the second bid based at least in part on historical data;
calculate, based at least in part on a value of a bid other than the second bid, a correction factor to apply to the second bid;
adjust the correction factor based at least in part on a risk associated with the second bid to generate an adjusted correction factor;
determine an auction value for the second bid based at least in part on the initial value and the adjusted correction factor; and
run an auction to identify one or more winning bids from the first bids and the second bid for satisfying the ad request.

18. A advertising management system comprising an auction engine, the auction engine being configured to:
identify first bids associated with an ad request where the first bids have an auction value that is set at a bidding time;
identify second bids associated with the ad request where the second bids have an auction value that is unknown at the bidding time;
determine one or more predicted auction values for the second bids; and
run an auction to identify one or more winning bids from the first and second bids for satisfying the ad request.

19. A advertising management system comprising an auction engine, the auction engine being configured to:
identify first bids associated with an ad request where the first bids have an auction value that is set at a bidding time;
identify a second bid associated with the ad request where the second bid has an auction value that is unknown at the bidding time;
calculate an initial value for the second bid based at least in part on historical data;
calculate, based at least in part on a value of a bid other than the second bid, a correction factor to apply to the second bid;
adjust the correction factor based at least in part on a risk associated with the second bid to generate an adjusted correction factor;
determine an auction value for the second bid based at least in part on the initial value and the adjusted correction factor; and
run an auction to identify one or more winning bids from the first bids and the second bid for satisfying the ad request.
